(19) United States
(12) Patent Application Publication
(10) Pub. No.: US 2026/0098616 A1
(43) Pub. Date: Apr. 9, 2026

(54) LIGHT ASSEMBLY AND METHOD THEREOF

(71) Applicant: HARMAN INTERNATIONAL INDUSTRIES, INCORPORATED, Stamford, CT (US)

(72) Inventor: Qiang WANG, Nanshan District, Shenzhen (CN)

(21) Appl. No.: 19/113,347

(22) PCT Filed: Sep. 21, 2022
(86) PCT No.: PCT/CN2022/120137

§ 371 Date: Mar. 19, 2025

(51) Int. Cl. F21S 2/00; F21V 23/00; F21V 23/06; F21Y 105/18; H05B 47/105; H05B 47/155

(52) U.S. Cl. CPC F21S 2/005; F21V 23/008; F21V 23/06; H05B 47/105; H05B 47/155; F21Y 2105/18

(57) ABSTRACT

A light assembly may include a plurality of light panels connected with one another and a controller connected to one of the plurality of light panels. A method may comprise discovering, by the plurality of light panels, a topology of the plurality of light panels in the light assembly to derive a topology information table; deriving, by the controller, a vertex information table based on the topology information table received from a downstream panel and an orientation of the light assembly, wherein the downstream panel is the one light panel connected to the controller; calculating light effect data for each vertex of each light panel, by each light panel, based on the vertex information table, upon receiving a timing clock signal from the controller; and rendering light effect, by each light panel, based on the calculated light effect data for each vertex of each light panel.

### TECHNICAL FIELD

The present disclosure relates to a light assembly and a method for the light assembly.

### BACKGROUND

Now, lighting products consisting of multiple configurable lighting units are becoming more and more popular. The multiple configurable lighting units can be removably connected one to another. Users can freely assemble multiple lighting units to form lighting products with different geometric shapes according to their own preferences. This requires a detection of a layout of all connected lighting units. Some existing layout detection methods only detect the relative adjacency information of lighting units, such as information that indicates which two lighting units are joined together and by which side they join. However, for more complex light effects such as orientation-dependent light effects, such layout detection is not enough. Moreover, in the existing controlling method for the lighting products, light data for each lighting unit are normally coordinated by a central controller. Animation light effects require large amounts of light data from the central controller, which then requires more powerful MCUs and dedicated high-speed bus that are more costly.

### SUMMARY

According to one aspect of the disclosure, a method for a light assembly is provided. The light assembly may include a plurality of light panels connected with one another and a controller connected to a downstream panel of the plurality of light panels. The method may comprise discovering, by the plurality of light panels, a topology of the plurality of light panels in the light assembly to derive a topology information table; deriving, by the controller, a vertex information table based on the topology information table received from a downstream panel and an orientation of the light assembly; calculating, by each light panel, light effect data for each vertex of each light panel, based on the vertex information table and upon receiving a timing clock signal from the controller; and rendering light effect, by each light panel, based on the calculated light effect data for each vertex of each light panel.

According to another aspect of the present disclosure, a light assembly is provided. The light assembly may comprise a plurality of light panels configurable to connect with one another; and a controller configurable to connect to a downstream panel of the plurality of light panels. The controller may be configured to derive a vertex information table based on a topology information table received from a downstream panel and an orientation of the light assembly. The topology information table may indicative a topology of the plurality of light panels in the light assembly. Each light panel of the plurality of light panels may include a panel controller. The panel controller may be configured to: receive and store the vertex information table; calculate light effect data for each vertex of the light panel based on the vertex information table; and control one or more light elements located on each vertex of the light panel to render light effect, based on the calculated light effect data for each vertex of the light panel.

### BRIEF DESCRIPTION OF THE DRAWINGS

FIG. 1 illustrates examples of light panels with different shapes according to one or more embodiments.

FIG. 2 illustrates an example of light assembly with an example topology according to one or more embodiments.

FIG. 3 illustrates an example of the method for a light assembly according to one or more embodiments of the present disclosure.

FIG. 4 illustrates a schematic diagram of different orientation angels for the light plate with the hexagon shape.

FIG. 5 shows a schematic diagram of different orientation angels for the light plate with the triangle shape.

FIG. 6 shows a schematic diagram of different orientation angels for the light plate with the diamond shape.

FIG. 7 illustrates examples of the light assembly with multiple light panels in different orientations.

FIG. 8 illustrates examples of the unit canvas with different orientations.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration, but are not intended to be exhaustive or limited to the embodiments disclosed. Many modifications and variations will be apparent to those of ordinary skill in the art without departing from the scope and spirit of the described embodiments.

In some embodiments, the light assembly may include a plurality of light panels and a controller. For example, the light panels may have different shapes such as a hexagon shape, a diamond shape and a triangle shape. When assembling the light assembly, users may connect the light panels one by one according to their preferences. That means, users can connect any side of any two panels in any orientation. Thus, the light assembly may be formed with larger different geometric shapes in appearance and accordingly may have different logical topologies of the light panels based on the user's different selections. Upon assembly, the light assembly may exhibit a variety of visual light effects.

The controller may be connected to any one light panel of the plurality of light panels and may be physically and electronically configured or designed so that it may share power, data, signal and command with whichever panel is connected to it. The controller may be integrated with one or more sensors (e.g., G-sensors) to sense its orientation.

Each light panel may be physically and electronically configured or designed so that the light panels may be interconnected and may share power, data, signal and command with amongst one another or with the controller. For example, each light panel may include one or more printed circuit boards that are adapted to transfer data between different light panels in the light assembly. Each light panel may further include one or more panel controller (e.g., MCUs) that are adapted to store and process data. Usually, one or more lighting elements (e.g., LED light) are located at vertices of each panel.

It is recognized that at least one panel controller and the controller as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, the at least one controller as disclosed herein utilize one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The disclosed controller(s) also include hardware-based inputs and outputs for receiving and transmitting data, respectively from and to other hardware-based devices.

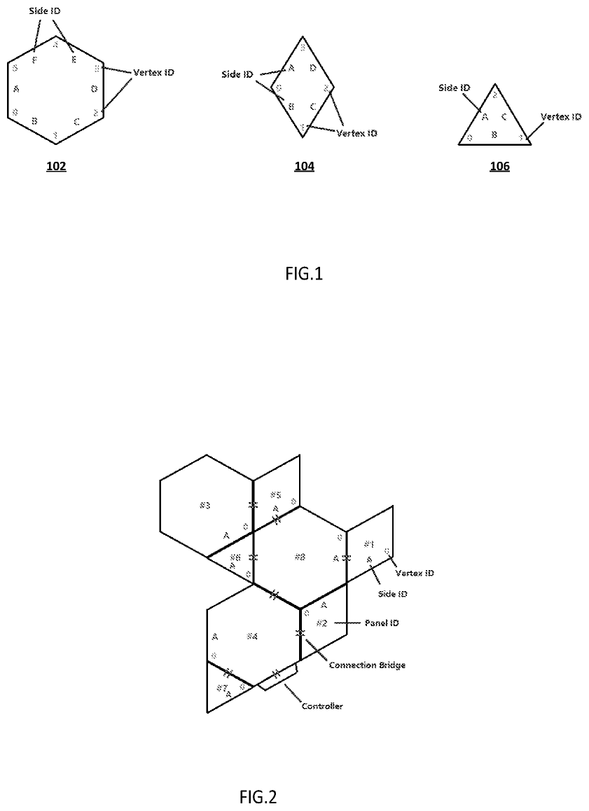

FIG. 1 illustrates examples of light panels with different shapes according to one or more embodiments. For example, FIG. 1 shows a light panel 102 with a hexagon shape, a light panel 104 with a diamond shape, and a light panel 106 with a triangle shape. Usually, each light panel has a unique identifier (ID). The unique ID may be assigned during manufacturing and stored in non-volatile memory in each panel and/or the controller. In addition, for each light panel, a side identifier may be pre-assigned to each side and a vertex ID may be pre-assigned to each vertex. For example, side IDs A-F are respectively assigned to six sides of the light panel 102 in a counter-clockwise sequence, and vertex IDs 0-5 are respectively assigned to six vertices of the light panel 102 in a counter-clockwise sequence. For example, side IDs A-D are respectively assigned to four sides of the light panel 104 in a counter-clockwise sequence, and vertex IDs 0-3 are respectively assigned to four vertices of the light panel 104 in a counter-clockwise sequence. For example, side IDs A-C are respectively assigned to three sides of the light panel 106 in a counter-clockwise sequence, and vertex IDs 0-2 are respectively assigned to three vertices of the light panel 106 in a counter-clockwise sequence. It can be understood that the assignments regarding side IDs and vertex IDs to each panel shown in FIG. 1 is only an example, so as to make the following description easier to understand. Other assignments regarding side IDs and vertex IDs (such as in a clockwise sequence, or any predefined sequence) may also be preset. The preset assignment information regarding side IDs and vertex IDs for each panel may be stored in non-volatile memory of the corresponding panel and/or the controller.

FIG. 2 illustrates an example of light assembly with an example topology according to one or more embodiments. It can be recognized that the topology shown in FIG. 2 is only an example and not for limitation. As shown in FIG. 2, for example, the light assembly may include a controller and light panels #1˜#8. The connection between two adjacent panels and the connection between the controller and any one panel can be realized by connection bridge components. The connection bridge components may include mechanical components and electronic circuits to enable physical connection and power, data, signal and command transmission.

In the example shown in FIG. 2, the controller is connected to panel #4 via a connection bridge. For the controller, the panel #4 may be called its downstream panel hereafter. For the panel #4, it connects respectively to panel #2, panel #7 and panel #8, and these panels may be called child panels of the panel #4 hereafter, which means these panels #2, #7 and #8 are downstream panels of the panel #4. And so on.

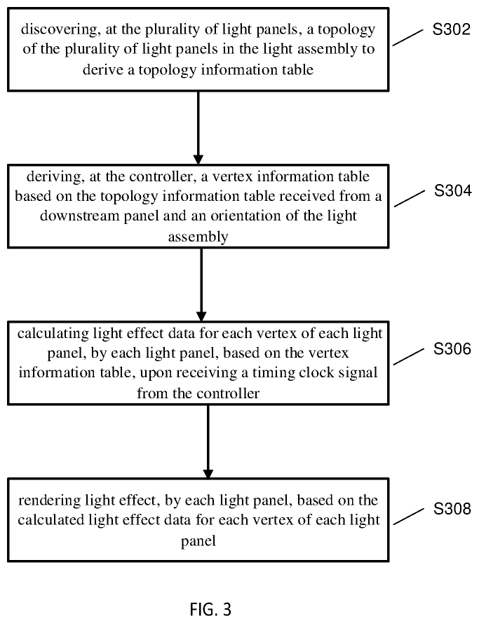

FIG. 3 illustrates an example of the method for a light assembly according to one or more embodiments of the present disclosure. In some embodiments, the light assembly may include a plurality of light panels connected with one another and a controller connected to one of the plurality of light panels. The one light panel connected to the controller may be called as a downstream panel of the controller.

At S302, the plurality of light panels may jointly detect or discover the topology of the plurality of light panels in the light assembly to derive a topology information table. In some embodiments, the topology information table may be indicative of logical connections in the topology for the plurality of light panels in the light assembly. The topology information may include the relative adjacency information of each light panel, such as information indicates which two light panel are connected together and by which side they connect. For example, the topology information table may be presented as a Panel-Sides table, which will be described in details later. In some examples, the completed topology information table may be transferred from the downstream panel to the controller.

At S304, the controller may derive a vertex information table based on the topology information table received from the downstream panel and an orientation of the light assembly, wherein the downstream panel is the one light panel connected to the controller. In some embodiments, the vertex information table may be indicative of relative location information for each vertex of each light panel in the light assembly. In some examples, the vertex information table may be presented as an XY-Coordinates table, which will be described in details later. In some embodiments, the vertex information table may be received by the downstream panel from the controller, via a command carrying an orientation index and the vertex information table. Then, the vertex information table may be forward to each light panel along the topology.

In some embodiments, the orientation index is indicative of an orientation of the light assembly and is associated with an orientation angle of the controller. In some examples, the orientation angle may be detected by one or more sensors (e.g., G-sensors) included in or integrated with the controller. The orientation angle may also indicate an angle between a reference side of the downstream panel and a horizontal axis in a positive direction, wherein the reference side of the downstream panel is a side that connects to the controller. In some examples, the detected orientation angle may be rounded to one of 12 levels within the 360 degrees circle, i.e., 0/30/60/90/120/150/180/210/240/270/300/330 degrees. These levels may be divided into two groups. For example, a first group may be 0/60/120/180/240/300/360 degrees, and a second group may be 30/90/150/210/270/330 degrees. If the detected orientation angle may be rounded to one angel in the first group, then the value of the orientation index is 0. If the detected orientation angle may be rounded to one angel in the second group, then the value of the orientation index is 1.

At S306, upon receiving a timing clock signal from the controller, each light panel may calculate light effect data for each vertex of each light panel, based on the vertex information table. In some embodiments, each light panel may calculate light effect data for each vertex of each light panel, based on the vertex information table and the orientation index.

At S308, each light panel may display its own light effect, based on the calculated light effect data for each vertex of each light panel. In some embodiments, each light panel may display its own light effect, based on the calculated light effect data for each vertex of each light panel and the orientation index. In some embodiments, the calculated light effect data is associated with the orientation index.

In addition, in some embodiments, light panels may track any change in topology, by detecting new panels being added to the light assembly, or existing light panels being removed from the light assembly. The light panels may notify controller of any change in topology, so the controller may update the topology information table and the vertex information table.

The abovesaid method according to one or more embodiments may enable user to freely assemble multiple light panels with different shapes. In the meantime, this method may determine the locations of each light element in such a flexible panel assembly by deriving the vertex information table indicative of relative position information for each vertex of each light panel in the light assembly. The locations of light element will enable the light panels to render animation light effects that adapt automatically to the topology and orientation of the light panel assembly, which allows the light panel assembly to exhibit richer, more complex animation themes, rather than just random color change themes. In addition, this method allows the light panels to individually create local light effects based on only a timing signal only from the controller. The local light effect is calculated based on location information of all light elements in the light panel assembly, to jointly create the overall animation light effect. By this method, the data transfer between the controller and light panels are greatly reduced, hence it does not require costly central controller (e.g., MCU) or high-speed hardware. Moreover, this method allows each light panel to compute the animation light effect data using the same algorithm, despite different shape of the lighting panel or different location of the light panel within the light assembly. The animation light effect may also adapt to the orientation information of the light assembly tracked by the controller. More details will be described hereafter.

### Topology Discovery

This part of “Topology Discovery” will detailed describe how to discover a topology of the plurality of light panels in the light assembly to derive the topology information table (such as a Panel-Sides table) according to one or more embodiments.

The topology discovery process may be started when any one of the following two conditions are met: the controller is initially started after the light assembly is powered up; and a topology change is detected.

In some examples, the topology discovery process may include that the controller send out a Topology Request command to its downstream panel, and waits for the downstream panel to reply. The downstream panel traverses all its sides to discover all its child panels. Each child panel continues to traverse its own sides and its downstream child panels (if any) until all child panels in the light assembly have been traversed. It can be understood that child panel refers to any downstream panel connected to the upstream panel. Each downstream child panel may store its data regarding connections information and report the same to its upstream panel. Thus, the downstream panel connected to the controller may finally complete the data regarding all the connections information in the light assembly and derive the Panel-Sides table. The Panel-Sides table is indicative of logical connections for all the light panels in the current topology structure. In other words, the Panel-Sides table may include the topology information for all panels connected logically in a tree structure. Then, the downstream panel sends a Topology Reply command including the Panel-Sides table to the controller. The controller now has the complete Panel-Sides table including the topology information for all panels connected logically in the light assembly. The topology discovery process is now complete.

The Topology Reply command is an upstream command from panels to the controller, and may have the following example data structure.

| Start | Command | | Value (max | |
|---|---|---|---|---|
| code | Type | Len | 11*N − 5 Bytes) | Checksum |
| 0xFF | 0x05 | 2 Bytes | empty or | 1 Byte |
| | | | Panel-Sides table | |
| | | | (see below) | |

Len = Length of Value field in Bytes

Panel-Sides table:

| Current | Current Panel | Child | Child Panel | Child Panel |
|---|---|---|---|---|
| Panel ID | Side ID | Panel ID | Side ID | FW Version |
| (4 Bytes) | (1 Byte) | (4 Bytes) | (1 Byte) | (1 Byte) |
| empty | empty | 4 | C | 0 |
| 4 | D | 2 | B | 0 |
| 4 | B | 7 | B | 0 |
| 4 | E | 8 | E | 0 |
| 8 | D | 6 | B | 0 |
| 8 | A | 1 | D | 0 |
| 8 | C | 5 | A | 0 |
| 5 | D | 3 | B | 0 |

Current/Child Panel ID format: First two digits shows the shape type of light panels. For example,
   Panel ID in range: 0x00 00 00 00—0x3F FF FF FF means Hexagon shape;
   Panel ID in range: 0x40 00 00 00—0x7F FF FF FF means Diamond shape;
   Panel ID in range: 0x80 00 00 00—0x8F FF FF FF means Triangle shape.
Current/Child Panel Side ID: A-F (Hexagon); A-D (Diamond); A-C (Triangle).
FW Version: 0-255, this field is reserved for future use.

The above Panel-Sides table is derived from the topology of the light assembly shown in FIG. 2 as an example. The topology discovery will be described in further detail below.

After the light assembly is powered up, all light panels are in “New Panel” state.

The controller starts sending out a Topology Request command (with Round=1) to its downstream panel, and waits for the downstream panel to reply.

When the downstream panel receives the Topology Request command, it labels itself as “Topology Started”, and starts forwarding the Topology Request command (with Round=1) to all its sides in an order. The order may be preset to be clockwise, counterclockwise or other particular order. The order may be set according to the different shape of the panel. In an example, a specific order for the hexagon shape and the diamond shape may be preset to a stroke order like “Z”, and a specific order for the triangle shape may be preset to be counterclockwise. It can be understood that other preset orders can also be used.

After sending out the Topology Request command to each side, this downstream panel as a current panel waits for its any downstream panel (i.e., its child panel) to reply.

In some examples, if there is no reply after a period of time, such as 5 ms, this current panel moves on to the next side. In some examples, if there is Topology Reply (command Type 0x05) with Len=0, this current panel moves on to the next side.

In some examples, if there is a Topology Reply (command Type 0x05) with Len>0, this current panel finds the half-empty entry in the Panel-Sides table, writes its own physical panel ID to Current Panel ID, writes the Topology Reply incoming side ID (i.e., the side from which the Topology Reply comes) to Current Side ID. By this way, a branch from the current panel may be completed. The current panel temporarily saves one completed branch, together with any other previous completed branches in a local panels-sides table. If all sides have not been polled, this current panel moves on to the next side.

The term of “branch” may be understood as a path from a tree root to a tree top in the tree structure of the panel-sides table. For example, the current panel (the tree root) is panel #4. Then, a branch may be a path from panel #4 to panel #2; a path from panel #4 to panel #7; a path from panel #4, passing through panel #8, to panel #6; a path from panel #4, passing through panel #8, to panel #1; a path from panel #4, passing through panel #8 and panel #5, to panel #3.

If all sides of a panel have been polled, a current panel labels itself as “Topology Complete” status, creates a new entry in the local Panel-Sides table, writes own physical panel ID into Child Panel ID, writes the Topology Request incoming Side ID into Child Panel Side ID, and sends a Topology Reply command with this new Panel-Sides table back to the Topology Request incoming Side.

In the manner described above, the Panel-Sides table indicative of logical connections for all the light panels in the light assembly may be derived, and a topology discovery process performed collectively by the panels may be completed. The Panel-Sides table may indicate which two lighting panels are connected together and by which side they are connected. The completed Panel-Sides table then may be sent to the controller from the downstream panel that is connected to the controller.

Each light panel should record locally the current Panel-Sides table which includes information regarding all its downstream child panels. Each light panel also stores locally the Topology Request incoming Side IDs. The above information will all be reset during a power cycle.

In some examples, for a light panel that receives a Topology Request (with the same round count that is a value included in one field of the Topology Request command), if this light panel is in a “Topology Started” or “Topology Complete” status, it sends a Topology Reply (command Type 0x05) with Value=empty, i.e., Len=0 back to the Topology Request incoming Side. If this Panel is in “New Panel” status, it starts forwarding the Topology Request command downstream as described above.

Finally, the controller receives the Topology Reply from its downstream panel. It now has the complete Panel-Sides table including connection information regarding all panels connected logically in a tree structure. The entire topology discovery process is now complete. With this complete Panel-Sides table, the controller may assign logic panel IDs mapped to each physical panel ID. The controller may also report the complete topology information (with logic panel IDs) to a WiFi module of the light assembly, so an App of a remote device controlled by users can update the topology display and light data calculation.

In some embodiments, the Panel-Sides table may be updated in real or near-real time as one or more new light panels are added to the light assembly or as one or more new light panels are removed from the light assembly. For example, the update may be completed by tracking topology changes as follows.

### Tracking Topology Changes

The following will describe the tracking process in the case of adding new light panels to an existing topology.

After power up, all light panels are in “New Panel” status. Each light panel that is with the “New Panel” status sends out a New Panel Hello command once every 2 s with a random variance of +/−1 s, to all its sides.

In some examples, when a light panel with the “New Panel” or “Topology Started” or “Topology Changed” status receives a New Panel Hello command from a neighbor panel, it ignores this New Panel Hello command.

In some examples, when a light panel with “Topology Complete” status receives a New Panel Hello command, it labels itself as “Topology Changed” status. Then, the light panel waits until the next Sync Pulse command from the controller is received, and immediately sends out a Topology Changed command back to the controller via its Topology Request incoming Side (i.e., the side from which the Topology Request comes). The Sync Pulse command is a downstream command from the controller to the light panel and is used as a timing clock signal from the controller.

In some examples, when a panel with “Topology Complete” status receives a Topology Changed command, the panel labels itself as “Topology Changed” status, and it immediately forwards the Topology Changed command to the controller via its Topology Request incoming Side.

In some examples, when the controller receives a Topology Changed command, it stops sending Sync Pulse commands, and starts a new round of topology discovery process by sending out a Topology Request command with a round count incremented by 1. The round count is a value included in one field of the Topology Request command.

Thus, the same topology discovery process as described above happens, except that when a light panel receives a Topology Request command with a new round count, it resets any existing panel-sides table, and behaves like a new Panel (with “New Panel” status).

Finally, the controller receives the Topology Reply message and completes the topology update.

The following will describe the tracking process in the case of removing light panels from an existing topology.

During a normal operation, for example, the controller sends Sync Pulse commands once every 500 ms, with a sync count incremented by 1 every time.

In some examples, when a panel (with “Topology Complete” status) receives a Sync Pulse command, it immediately forwards this Sync Pulse command to all its downstream Child Panels only, and then sends a Sync Reply command back to the upstream Panel.

In some examples, if a panel receives a Sync Reply, it ignores it. In some examples, if a panel does not receive the Sync Reply within 5 ms after sending out the Sync Pulse, it labels itself as “Topology Changed” status, and immediately sends a Topology Changed command upstream to the controller via the Sync Pulse incoming Side (i.e., the side from which the Sync Pulse comes).

In some examples, if the controller does not receive the Sync Reply within 5 ms after sending out the Sync Pulse, or when it receives a Topology Changed command later, it stops sending Sync Pulses, and starts a new round of topology discovery process by sending out a Topology Request command with the round count incremented by 1.

Then, the same topology discovery process happens, except that when a light panel receives a Topology Request command with a new Round Count, it resets any existing panel-sides table, and behaves like a new panel (with “New Panel” status).

Finally, the controller receives the Topology Reply message and completes the topology update.

For both the tracking process in the case of adding new light panels to an existing topology and the tracking process in the case of removing light panels from an existing topology, it should be noted that, when a panel with “Topology Changed” status receives a Sync Pulse (command Type 0x00), it immediately sends a Topology Changed command upstream to the controller via the Sync Pulse incoming Side.

### Calculating XY Coordinates

This part of “Calculating XY Coordinates” will detailed describe how to derive by the controller, a XY-coordinates table based on the Panel-Sides table received from the downstream panel that is connected to the controller. The XY-Coordinates table may be indicative of coordinates information regarding each vertex of each light panel in the light assembly.

The controller derives or updates the XY-Coordinates table after the following trigger events:
a topology discovery process (after power up) is complete; or
a topology change is detected and a topology update process is complete; or
an orientation change is detected.

The orientation is important information for forming/deriving/updating the XY-Coordinates table by modeling. The orientation may be used to characterize the installation orientation of the light assembly, which can also reflect information about an angle between a reference side of the downstream panel and the horizontal axis in a positive direction. The controller may detect the orientation and the orientation change by at least one sensor.

To simplify the model, according to the geometrical properties of the geometry of the light panel (e.g., with hexagon shape, diamond shape or triangle shape), the orientation is rounded to one of 12 levels within the 360 degrees circle, i.e., 0/30/60/90/120/150/180/210/240/270/300/330 degrees. These levels may be divided into two groups. For example, one group may be 0/60/120/180/240/300/360 degrees, and the other group may be 30/90/150/210/270/330 degrees.

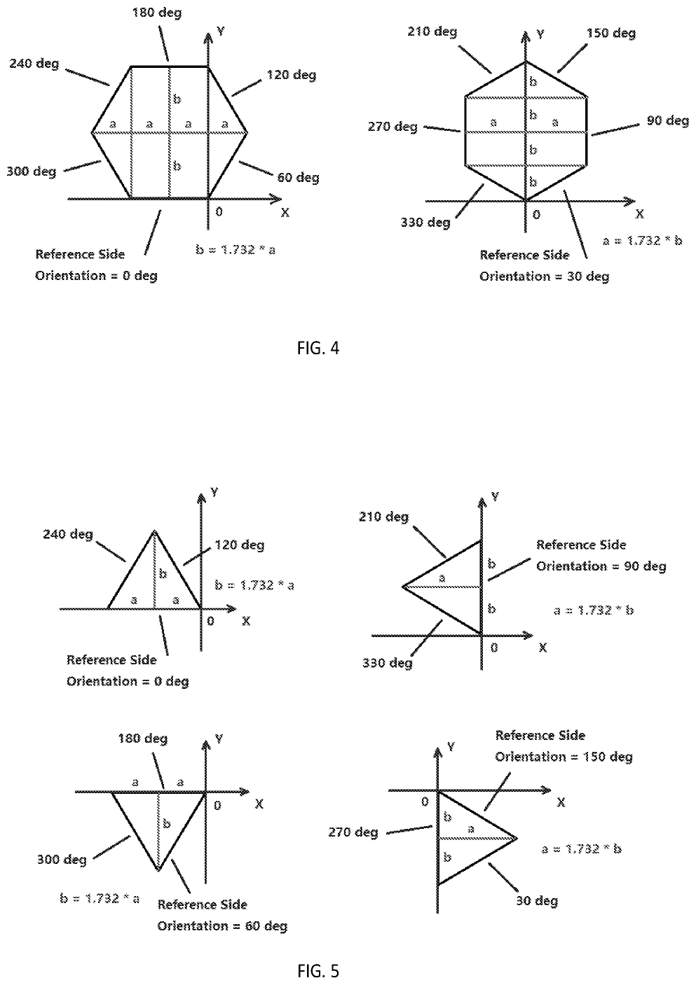

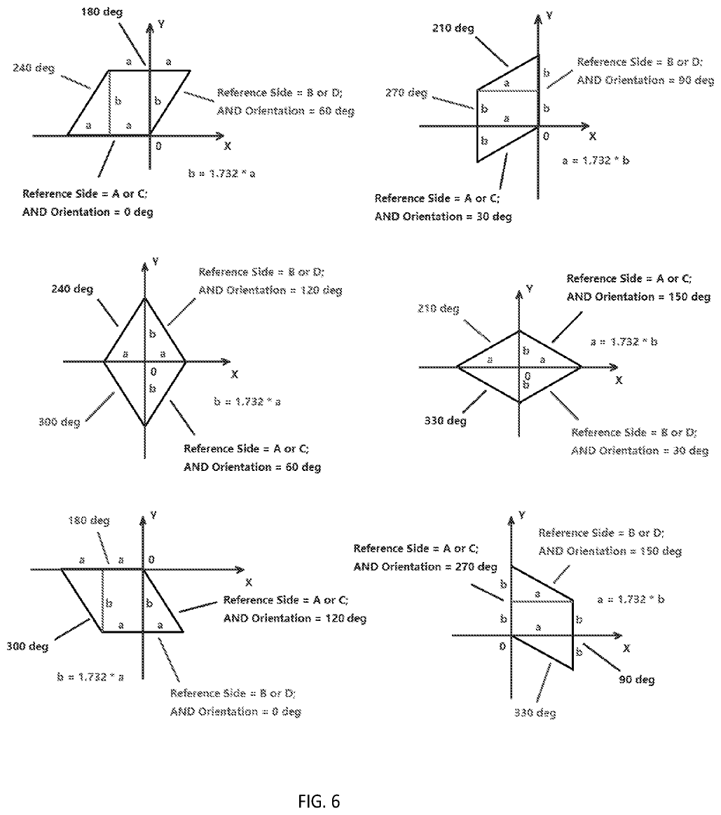

FIG. 4 shows a schematic diagram of different orientation angels for the light plate with the hexagon shape. FIG. 5 shows a schematic diagram of different orientation angels for the light plate with the triangle shape. FIG. 6 shows a schematic diagram of different orientation angels for the light plate with the diamond shape.

For better understanding, line segments a and b are specifically labeled in each panel in FIGS. 4-6. According to the geometric properties of equilateral hexagon, equilateral quadrilateral (diamond) and equilateral triangle, it can be understood that the proportional relationship between a and b can be determined. These figures also show the proportional relationship between a and b in each orientation case. It should be noted that a and b are not be set to any specific numerical values, and can be understood as length units, which are related to the side lengths of the equilateral hexagon, the equilateral quadrilateral, and the equilateral triangle.

In general, if the orientation is rounded to 0/60/120/180/240/300/360 degrees, the proportional relationship between a and b is set to b=1.732*a; where a=hexagon edge length/2. If the orientation is rounded to 30/90/150/210/270/330 degrees, the proportional relationship between a and b is set to a=1.732*b; where b=hexagon edge length/2.

Depending on the orientation, the X, Y coordinates of all vertices of the light panels with all shapes can be represented as:
X coordinate=X value*a; Y coordinate=Y value*b; wherein X value and Y value may be any integer.

Thus, combining the above descriptions with reference to FIGS. 1-6, relative positional relationships of each vertex of each side of each type of light panel in different orientations (i.e., orientation angles) can be obtained. Based on these relative positional relationships, a lookup table can be formed. The lookup table may be pre-stored in the controller and each light panel. For ease of understanding, we list a portion of this lookup table below.

| | | Reference | | | | | | | | | | | | | | | | | | |
|---|---|---|---|---|---|---|---|---|---|---|---|---|---|---|---|---|---|---|---|---|
| | | Side | Reference | | | | | | | | | | | | | | | | | |
| Panel | Reference | Orientation | Vertex | | | Remaining Vertices | | | | | | | | | | | | | | |
| Type | Side ID | (degree) | ID | X | Y | ID | X | Y | ID | X | Y | ID | X | Y | ID | X | Y | ID | X | Y |
| Hexagon | A | 0 | 0 | x | y | 1 | x + 1 | y + 1 | 2 | [symbol] | y + 2 | 3 | x − 2 | y + 2 | 4 | x − 3 | y + 1 | 5 | x − 2 | y |
| | | 30 | 0 | x | y | 1 | x | y + 2 | 2 | x − 1 | [symbol] | 3 | x − 2 | y + 2 | 4 | x − 2 | y | 5 | x − 1 | [symbol] |
| | | 60 | 0 | x | y | 1 | x − 1 | y + 1 | 2 | x − 3 | y + 1 | 3 | x − 4 | y | 4 | x − 3 | y − 1 | 5 | x − 1 | y − 1 |
| | | 90 | 0 | x | y | 1 | x − 1 | y [symbol] 1 | 2 | x + 2 | y | 3 | x − 2 | y [symbol] 2 | 4 | x − 1 | y − 3 | 5 | [symbol] | y − 2 |
| | | 120 | 0 | x | y | 1 | x − 2 | y | 2 | x − 3 | y − 1 | 3 | x − 2 | y − 2 | 4 | x | y − 2 | 5 | x + 1 | y − 1 |
| | | 150 | 0 | x | y | 1 | x − 1 | [symbol] | 2 | x − 1 | [symbol] | 3 | x | y − 4 | 4 | x + 1 | y − 3 | 5 | [symbol] | [symbol] |
| | | 180 | 0 | x | y | 1 | x − 1 | y − 1 | 2 | x | y − 2 | 3 | x + 2 | y − 2 | 4 | x + 3 | y − 1 | 5 | x + 2 | y |
| | | 210 | 0 | x | y | 1 | x | y − 2 | 2 | x + 1 | [symbol] | 3 | x + 2 | y [symbol] 2 | 4 | x + 2 | y | 5 | [symbol] 1 | [symbol] |
| | | 240 | 0 | x | y | 1 | x + 1 | y − 1 | 2 | x + 3 | y − 1 | 3 | x + 4 | y | 4 | x + 3 | y + 1 | 5 | x + 1 | y + 1 |
| | | 270 | 0 | x | y | 1 | x + 1 | [symbol] | 2 | x + 2 | [symbol] | 3 | x + 2 | y + 2 | 4 | x + 1 | [symbol] | 5 | [symbol] | y + 2 |
| | | 300 | 0 | x | y | 1 | x + 2 | y | 2 | x + 3 | y + 1 | 3 | x + 2 | y + 2 | 4 | x | y + 2 | 5 | x − 1 | y + 1 |
| | | 330 | 0 | x | y | 1 | x + 1 | y + 1 | 2 | [symbol] | y + [symbol] | 3 | [symbol] | y + 4 | 4 | x − 1 | y + 3 | 5 | [symbol] | [symbol] |

[symbol]

indicates data missing or illegible when filed

For example, referring to FIG. 4, for the panel with the hexagon shape, assuming the reference side is “A”, then the reference vertex is the right-hand vertex of the reference side “A”. According to the example of preset of the side ID and vertex ID shown in FIG. 1, it can be known the ID of the reference vertex is “0”. For example, suppose the X coordinate and Y coordinate of the reference vertex “0” may be set to “x” and “y”, respectively. Suppose the orientation angle of reference side “A” is 0 degree. Then, based on the abovesaid lookup table (1^{st} row in above diagram), the X coordinate and Y coordinate of the reference vertex “1” may be calculated as “x+1” and “y+1”, respectively. Similarly, the remaining vertices may be calculated and preset. By analogy, the X values and Y values of all vertices of all sides of all types of light panels in different orientations can be obtained.

In some examples, the lookup table includes a mapping among the following for each light panel: the panel type, the reference side ID, the orientation of the reference side, X and Y values of the reference vertex, and X and Y values of the remaining vertices.

In some embodiments, based on the information of the above lookup table and the Panel-sides table, the controller may calculate x and y coordinates of all vertices of all the panels in the light assembly and derive the XY-Coordinates table.

In some examples, based on the Panel-Sides table and the Lookup table, the controller may perform the following steps:
S1: the controller may calculate all the x and y coordinates of all vertices of the downstream panel that is connected to the controller;
S2: the controller may calculate all x and y coordinates of all vertices of at least one next downstream child panel that is connected to the downstream panel;
S3: the controller may calculate all x and y coordinates of all vertices of at least one child panel downstream to the at least one next downstream child panel, until all x and y coordinates of all the vertices of all panels in the light assembly are obtained; and
S4: the controller may complete the XY-Coordinates table and send a XY Table command with the XY-Coordinates table down the topology to all light panels.

The details of S1-S4 will be described below.

In S1, based on the topology information recorded in the Panel-Sides Table, the controller may finds out the panel ID for the downstream panel that is connected to the controller (for example, the panel ID is usually recorded as the Child Panel ID in the first row of the Panel-Sides table), accordingly finds out the Child Panel Side ID for the downstream panel that is connected to the controller. The downstream panel indicated by the Child Panel ID may be as Current Panel.

Based on the Child Panel Side ID and an orientation of the child panel side indicated by the Child Panel Side ID, the controller may check out the Reference Vertex ID from the lookup table, and set the 1st Reference Vertex X=0, Y=0. For example, Panel Type indicating the shape type may be extracted by the controller from the panel ID (i.e., Child Panel ID). The orientation of the child panel side can be detected by a sensor positioned in the controller since the controller is connected to the child panel side and then it is round to a level of degree as we have discussed above.

Now, the controller gets the Panel Type, Reference Side ID (corresponding to the Child Panel Side ID), Reference Side Orientation (corresponding to the orientation of the child panel side), and the Reference Vertex ID. Then, from the lookup table, the controller may check out the Remaining Vertices. Since the x and y coordinates of Reference Vertex is set to X=0, Y=0, the controller may work out all the x and y coordinates of the remaining vertices.

In view of the above, the controller may calculate all the x and y coordinates of all vertices of the downstream panel that is connected to the controller. In some examples, the controller may fill the corresponding panel ID of the downstream panel, the panel logic ID (which is assigned by the controller based on the detected topology), and all the x and y coordinates of all vertices of the downstream panel to one row of the XY-Coordinates table.

In S2, from the Panel-Sides Table, the next downstream Child Panel's ID may be checked out, and the Current Panel Side ID and the Child Panel Side ID will be obtained. The Current Panel Side ID is indicative of an ID of the current panel' side that connects to the next downstream child panel, which also be referred to a “Current Panel's Side ID” hereafter. The Child Panel Side ID is indicative of an ID of the child panel' side that connects to the current panel, which also be referred to a “next downstream Child Panel's Side ID” hereafter.

Then, the orientation of the current panel' side that connects to the next downstream child panel may be calculated based on the orientation of current panel's reference side (which is indicated by the Current Panel Side ID in the Panel-Sides table) that connects to its parent panel. Accordingly, the orientation of the next downstream child panel's side that connects to the current panel may be determined based on the orientation of the current panel' side.

In some embodiments, the determination of the orientation of the current panel' side that connects to the next downstream child panel may be varied depending on the shape of the current panel. The determination will be detailed described in combination with the following examples.

For Current Panel=Hexagon shape:
SD0=Current Panel's Reference Side ID that connects to its Parent Panel;
SD1=Current Panel's Side ID that connects to the next downstream Child Panel;
SD0 Orientation=Reference Side Orientation;
If SD1>SD0, then SD1 Orientation=SD0 Orientation+(SD1−SD0)*60;
If SD1<SD0, then SD1 Orientation=SD0 Orientation−(SD0−SD1)*60;
If SD1 Orientation>=360, then SD1 Orientation=SD1 Orientation−360;
If SD1 Orientation<0, then SD1 Orientation=SD1 Orientation+360.

### For Current Panel=Diamond Shape:

SD0=Current Panel's Reference Side ID that connects to its Parent Panel;
SD1=Current Panel's Side ID that connects to the next downstream Child Panel;
SD0 Orientation=Reference Side Orientation;
Use below table to get SD1 Orientation.

| | SD0 Orientation | SD1 Orientation | | |
|---|---|---|---|---|
| Side ID | A | B | C | D |
| Orientation | o | o + 60 | 0 + 180 | 0 + 240 |
| Side ID | B | A | C | D |
| Orientation | o | o − 60 | o + 120 | o + 180 |
| Side ID | C | A | B | D |
| Orientation | o | o − 180 | o − 120 | o + 60 |
| Side ID | D | A | B | C |
| Orientation | o | o − 240 | o − 180 | o − 60 |

### For Current Panel=Triangle Shape:

SD0=Current Panel's Reference Side ID that connects to its Parent Panel;
SD1=Current Panel's Side ID that connects to the next downstream Child Panel;
SD0 Orientation=Reference Side Orientation;
If SD1>SD0, then SD1 Orientation=SD0 Orientation+(SD1−SD0)*120;
If SD1<SD0, then SD1 Orientation=SD0 Orientation−(SD0−SD1)*120;
If SD1 Orientation>=360, then SD1 Orientation=SD1 Orientation−360;
If SD1 Orientation<0, then SD1 Orientation=SD1 Orientation+360.

Let SD2=the next downstream Child Panel's Side ID that connects to the Current Panel.

Then, SD2 Orientation=(SD1 Orientation+180) % 360 degree, wherein the “%” represents the mathematical operator symbol “mod”.

From the Panel-Sides table, the controller may check the next downstream Child Panel ID and Child Panel Side ID. Then, the controller may get the following information:
Panel Type from Panel ID;
Reference Side ID=Child Panel Side ID=SD2;
Orientation=SD2 Orientation (from above); and
Reference Vertex ID=Reference Side ID−“A”.

In other word, the controller now gets the Panel Type, Reference Side ID, Reference Side Orientation (corresponding to the abovesaid Orientation), and the Reference Vertex ID. Then, from the lookup table, the controller may check out the Remaining Vertices. For example, suppose the X and Y coordinates of Reference Vertex is set to x, y, respectively, the controller may work out all the X and Y coordinates of the remaining vertices.

In view of the above, the controller may calculate all x and y coordinates of all vertices of the next downstream child panel that is connected to the downstream panel. In some examples, the controller may fill the corresponding panel ID of the next downstream child panel, the corresponding panel logic ID (which is assigned by the controller based on the detected topology), and all the x and y coordinates of all vertices of the next downstream child panel to one row of the XY-Coordinates table.

Then, the controller may repeat the above actions from the beginning of S2, and then may calculate all x and y coordinates of all vertices of all other next downstream child panel that is connected to the downstream panel. Accordingly, the controller may calculate all x and y coordinates of all vertices of at least one next downstream child panel that is connected to the downstream panel, and fill those information into the XY-Coordinates table.

In S3: the controller may repeat the actions of S2, and calculate all x and y coordinates of all vertices of at least one child panel downstream to the at least one next downstream child panel, until all x and y coordinates of all the vertices of all panels in the light assembly are obtained.

In S4: the controller may complete the XY-Coordinates table and send a XY Table command down the topology to all light panels. The XY Table command may carry the XY-Coordinates table and an orientation index. The orientation index may be indicative of an orientation of the light assembly and is associated with an angle between a reference side of the downstream panel that connects to the controller and a horizontal axis in a positive direction, wherein the reference side of the downstream panel is a side that connects to the controller. In some examples, the orientation index may have a value of 0 or 1 as described above.

When a light panel receives an XY Table command, it stores XY-Coordinates table included in the XY Table command and forward the XY Table commands to respective downstream panels.

For better understanding, we list the XY Table command and an example of the XY-Coordinates table derived from the exemplary topology shown in FIG. 2.

XY Table Command (from Controller to Panels Downstream)

| Start | Command | | Orientation | Value | |
|---|---|---|---|---|---|
| code | Type | Len | (1 Byte) | (max 29N | Checksum |
| 0xFF | 0x06 | 2 | 0: b = 1.732*a; | XY-Coordinates | 1 Byte |
| | | Bytes | 1: a = 1.732*b. | table (see below) | |

Len=Length of Value field in Bytes
Orientation value=0: means Orientation angle=0/60/120/180/240/300 degrees
Orientation value=1: means Orientation angle=30/90/150/210/270/330 degrees
The orientation value means the value of the orientation index.

XY-Coordinates table:

| Panel ID | Panel Logic ID | X0 | Y0 | X1 | Y1 | | X5 | Y5 |
|---|---|---|---|---|---|---|---|---|
| (4 Bytes) | (1 Byte) | (2 Bytes) | (2 Bytes) | (2 Bytes) | (2 Bytes) | . . . | (2 Bytes) | (2 Bytes) |
| 4 | 0 | −2 | 0 | −1 | −1 | . . . | −2 | 2 |
| 2 | 1 | 0 | 2 | 0 | 0 | . . . | empty | empty |
| 7 | 2 | −1 | −1 | −2 | 0 | . . . | empty | empty |
| 8 | 3 | 1 | 5 | 0 | 6 | . . . | 1 | 3 |
| 6 | 4 | −1 | 3 | −1 | 5 | . . . | empty | empty |
| 1 | 5 | 2 | 4 | 2 | 6 | . . . | empty | empty |
| 5 | 6 | 0 | 6 | 0 | 8 | . . . | empty | empty |
| 3 | 7 | −1 | 5 | −1 | 7 | . . . | −2 | 4 |

Panel ID format: it is physical Panel ID unique to every panel. For example, the first two digits shows Shape Type:
   Panel ID in range: 0x00 00 00 00—0x3F FF FF FF means Hexagon shape;
   Panel ID in range: 0x40 00 00 00—0x7F FF FF FF means Diamond shape;
   Panel ID in range: 0x80 00 00 00—0x8F FF FF FF means Triangle shape.
Panel Logic ID format: 0-255; it is logic ID for each panel in the completed topology.
The Panel Logic ID is assigned by the controller. Each Panel Logic ID maps to one physical Panel ID. Panel Logic IDs may be used in light data transmission later.
Xn & Yn=X & Y coordinates of Vertex ID n;
X coordinate=X value*a; Y coordinate=Y value*b;
If Orientation=0, b=1.732*a; where a=hexagon edge length/2.
If Orientation=1, a=1.732*b; where b=hexagon edge length/2.

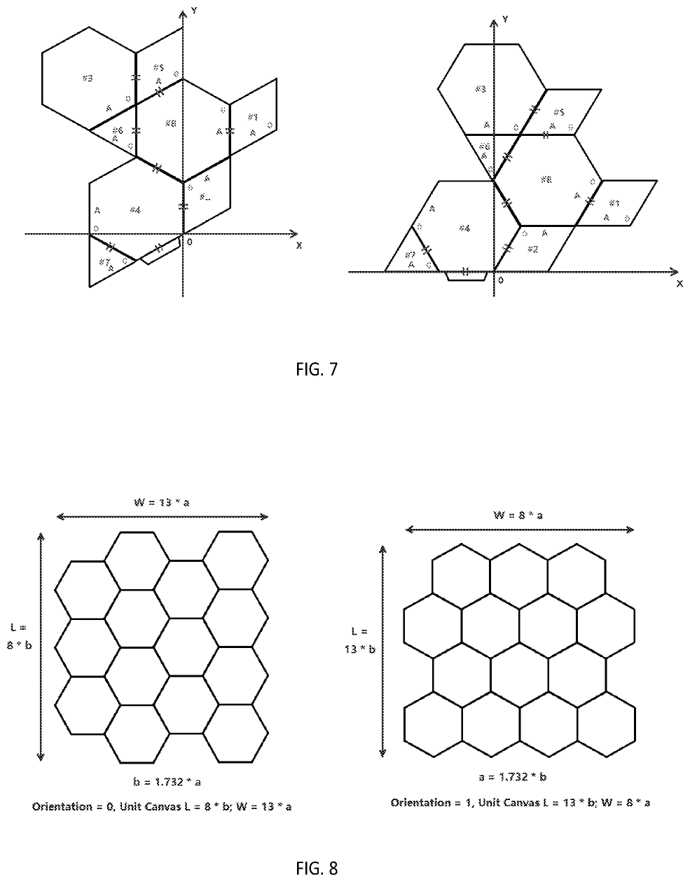

FIG. 7 illustrates examples of the light assembly with multiple light panels in different orientations. The left example shows the case of Orientation=1, and the left example shows the case of Orientation=0.

When each light panel receives the XY Table command, it copies the Logic Panel IDs for itself and all other panels into the local Panel Side table stored, so each panel knows which Logic ID maps to which physical Panel ID in the local Panel Sides table.

### Continuous Light Settings

The light assembly may be controlled by physical buttons, or remotely controlled by a device with APP via WiFi module of the light assembly. After receiving new commands from either WiFi module or physical buttons, the controller may send a command for dynamic lighting effect controls, for example, a theme mode command. After each light panel receives the theme mode command, it starts to update local light effect after receiving each sync pulse command (i.e., each timing clock signal).

In some embodiments, in response to receiving each sync pulse command, each light panel calculates each light effect data for each vertex thereof; and each light panel updates its own light effect based on each light effect data of each vertex. The light effect data may be calculated based on theme data, period data and location data.

In some examples, the theme data is associated with an animation theme of an animation light effect. The animation theme may be checked from the theme mode command by each light panel after receiving the theme mode command. The theme mode command may carry a theme index indicating an animation theme. Different indices may indicate different animation themes. For example, if the theme index is 0, it indicates the animation theme of horizontal wave moving up; if the theme index is 1, it indicates the animation theme of vertical wave moving right; if the theme index is 2, it indicates the animation theme of diagonal wave moving right-up, and so on. It can be understood that other animation themes may be indicated by other indices.

According to the theme index, each light panel may get corresponding parameters associated with the corresponding animation theme, based on pre-stored theme information in each panel controller (e.g., MCU). For example, the parameters associated with the animation theme may include a color range, an animation cycle period, and so on.

In some embodiments, the period data may be associated with at least one of the following parameters: a sync pulse period, a frame period, a number of sync pulses per cycle, a number of frames per seconds, a number of frames per sync period, a number of frames per cycle, and a pulse count and a frame count.

For example, the sync pulse period depends on the period at which the controller sends a sync pulse command. For example, the sync pulse period (Tsync) may be 500 ms according the system configuration. The frame period may be calculated based on a frame rate. For example, the frame rate may be 50 fps according the system configuration. Then, the frame period (Tf) may be calculated, i.e., Tf= 1/50 fps=20 ms. Thus, it can be determined that each light panel updates local light effect 25 times (500 ms/20 ms) after receiving every sync pulse command. For example, the sync pulse command may include a value of sync pulse count. The value of sync pulse count is increased increment by 1 with every new sync pulse command.

For example, based on the sync pulse period, the frame period and the animation cycle period, these parameters (such as the number of sync pulses per cycle, the number of frames per seconds, the number of frames per sync period, the number of frames per cycle and the frame count), may be calculated.

In other words, the period data is associated with data used to calculate which time period in the animation theme the current time corresponds to.

In some embodiments, the location data may be associated with X and Y coordinates of vertices in the XY-Coordinates table, and a size of a unit canvas. The unit canvas is a logical 2D area for displaying one complete cycle of an animation light effect. Outside this unit canvas area, the animation light effect will be repeated. The size of the unit canvas includes a length of the unit canvas and a width of the unit canvas. The length of the unit canvas and the width of the unit canvas may be predefined associated with the orientation of the light assembly (e.g., indicated by orientation index).

FIG. 8 illustrates examples of the unit canvas with different orientations. In the examples in FIG. 8, the light panels are shown as hexagon shape. However, it can be understood that the light panels may have different shapes and the topology of the light panels may differ from that shown in FIG. 8. The examples shown in FIG. 8 are only for illustration and not for limitation.

For example, the unit canvas size may be fixed as below.

If the orientation index is 0, the length and width of the unit canvas may be defined as: L=8*b, W=13*a, where b=1.732*a.

If the orientation index is 1, the length and width of the unit canvas may be defined as: L=13*b, W=8*a, where a=1.732*b.

Based on the calculated location data, each light panel may determine location information regarding each vertex of each light panel. The location information indicates which canvas and where in the canvas each vertex of each light panel is located.

In view of the above, the light effect data for each vertex of each panel may be calculated based on theme data, period data and location data. To sum up, each panel can obtain light effect data for each vertex of each light panel, and render the corresponding light effect based on the obtained light data. More specifically, one or more lighting elements at each vertex of each light panel may present different light effects, which causes each light panel to render rich lighting effects, and thus enables the light assembly to display more complex animation lighting effect. The control method provided by the present disclosure can control the display effects of the light panels more accurately through coordinates calculation for each vertex of each light panel, so that the light assembly consisting of the light panels can show better and richer visual effect.

The three examples with more details for calculating light effect data for each vertex are provided below. It is recognized that these examples are only for illustration, and are not intended to be exhaustive or limited to the embodiments disclosed. Any changes or modification can be made according to the practice requirement.

### Theme 0: Horizontal Wave Moving Up (Theme Mode=0)

Color (HSV) Range:
   HSV Hue: 1-360
   HSV Saturation: fixed to 255
   HSV Value: one of these levels: 15/31/47/63/79/95/111/127
Animation Cycle Period: T=8 s
No. of Sync Pulses per Cycle=T/Tsync=6 s/500 ms=16
No. of Frames per seconds FPS=50
No. of Frames per Sync Period=FPS*Sync Period=50*0.5 s=25
No. of Frames per Cycle=T*FPS=8*50=400
Δhue per Frame=Hue range per Cycle/No. of Frames per Cycle=360/400=0.9
Xmin=minimum of X coordinates of all vertices in the XY Table
Ymin=minimum of Y coordinates of all vertices in the XY Table
Xmax=maximum of X coordinates of all vertices in the XY Table
Ymax=maximum of Y coordinates of all vertices in the XY Table
Pulse Count=Sync Pulse Count % 16=0, 1, 2 . . . 15, incremented by 1 with every Sync Pulse;
Frame Count=0, 1, 2 . . . 24; starts to increment from 0 after every Sync Pulse comes in.
When Orientation=0, at Vertex (X, Y):

$$Hue value = \{ Pulse Count * Hue Range / 16 + [ ( Y - Ymin ) \% 8 ] * Hue Range / 8 + Frame Count * 0.9 \} \% 360$$

When Orientation=1, at Vertex (X, Y):

$$Hue value = \{ Pulse Count * Hue Range / 16 + [ ( Y - Ymin ) \% 13 ] * Hue Range / 13 + Frame Count * 0.9 \} \% 360$$

### Theme 1: Vertical Wave Moving Right (Theme Mode=1)

Color (HSV) Range:
   HSV Hue: 1-360
   HSV Saturation: fixed to 255
   HSV Value: one of these levels: 15/31/47/63/79/95/111/127
Animation Cycle Period: T=8 s
No. of Sync Pulses per Cycle=T/Tsync=6 s/500 ms=16
No. of Frames per seconds FPS=50
No. of Frames per Sync Period=FPS*Sync Period=50*0.5 s=25
No. of Frames per Cycle=T*FPS=8*50=400
Δhue per Frame=Hue range per Cycle/No. of Frames per Cycle=360/400=0.9
Xmin=minimum of X coordinates of all vertices in the XY Table
Ymin=minimum of Y coordinates of all vertices in the XY Table
Xmax=maximum of X coordinates of all vertices in the XY Table
Ymax=maximum of Y coordinates of all vertices in the XY Table
Pulse Count=Sync Pulse Count % 16=0, 1, 2 . . . 15, incremented by 1 with every Sync Pulse;
Frame Count=0, 1, 2 . . . 24; starts to increment from 0 after every Sync Pulse comes in.
When Orientation=0, at Vertex (X, Y):

$$Hue value = \{ Pulse Count * Hue Range / 16 + [ ( X - Xmin ) \% 13 ] * Hue Range / 13 + Frame Count * 0.9 \} \% 360$$

When Orientation=1, at Vertex (X, Y):

$$Hue value = \{ Pulse Count * Hue Range / 16 + [ ( X - Xmin ) \% 8 ] * Hue Range / 8 + Frame Count * 0.9 \} \% 360$$

### Theme 2: Diagonal Wave Moving Right-Up (Theme Mode=2)

Color (HSV) Range:
   HSV Hue: 1-360
   HSV Saturation: fixed to 255
   HSV Value: one of these levels: 15/31/47/63/79/95/111/127
Animation Cycle Period: T=8 s
No. of Sync Pulses per Cycle=T/Tsync=6 s/500 ms=16
No. of Frames per seconds FPS=50
No. of Frames per Sync Period=FPS*Sync Period=50*0.5 s=25
No. of Frames per Cycle=T*FPS=8*50=400
Δhue per Frame=Hue range per Cycle/No. of Frames per Cycle=360/400=0.9
In XY Table, for every Vertex, calculate sum of its XY coordinates: SumXY=X+Y.
Collect all these Sum values in an array and sort from the minimum to the maximum.
Sum_min=minimum of SumXY values of all vertices in the XY Table
Sum_max=maximum of SumXY values of all vertices in the XY Table
Pulse Count=Sync Pulse Count % 16=0, 1, 2 . . . 15, incremented by 1 with every Sync Pulse;
Frame Count=0, 1, 2 . . . 24; starts to increment from 0 after every Sync Pulse comes in.
At Vertex (X, Y):

$$Hue value = \{ Pulse Count * Hue Range / 16 + [ ( X + Y - Sum\_min ) \% 10 ] * Hue Range / 10 + Frame Count * 0.9 \} \% 360$$

Clause 1. In some embodiments, a method for a light assembly, wherein the light assembly includes a plurality of light panels connected with one another and a controller connected to a downstream panel of the plurality of light panels, the method comprising: discovering, by the plurality of light panels, a topology of the plurality of light panels in the light assembly to derive a topology information table; deriving, by the controller, a vertex information table based on the topology information table received from the downstream panel and an orientation of the light assembly; calculating, by each light panel, light effect data for each vertex of each light panel, based on the vertex information table and upon receiving a timing clock signal from the controller; rendering light effect, by each light panel, based on the calculated light effect data for each vertex of each light panel.

Clause 2. The method according to Clause 1, wherein the topology information table is indicative of logical connections in the topology for the plurality of light panels in the light assembly.

Clause 3. The method according to any one of Clauses 1-2, wherein the vertex information table is indicative of relative location information for each vertex of each light panel in the light assembly.

Clause 4. The method according to any one of Clauses 1-3, wherein the orientation of the light assembly is detected by the controller and is associated with an orientation angle of the controller.

Clause 5. The method according to any one of Clauses 1-4, wherein the deriving the vertex information table comprises: calculating all the x and y coordinates of all vertices of the downstream panel, based on the topology information table, a lookup table and the orientation; and calculating all x and y coordinates of all vertices of all remaining light panels downstream of the downstream panel along the topology, based on the topology information table, the lookup table and the orientation.

Clause 6. The method according to any one of Clauses 1-5, wherein the lookup table is predefined and includes mapping relations among the following: panel types for the light panels, reference side IDs for the reference sides, reference side orientations indicative of rounded angles between the reference sides of the downstream panel and a horizontal axis in a positive orientation, X and Y values of reference vertices of the reference sides, and X and Y values of remaining vertices of the light panels.

Clause 7. The method according to any one of Clauses 1-6, wherein the calculating light effect data for each vertex of each light panel is further comprising calculating light effect data for each vertex of each light panel based on a theme indicated by a theme mode command received from the controller, the orientation and the vertex information table.

Clause 8. The method according to any one of Clauses 1-7, wherein the rendering light effect by each light panel further comprising rendering light effect based on the light effect data for each vertex of each light panel and the orientation.

Clause 9. The method according to any one of Clauses 1-8, wherein the light effect data is calculated based on theme data, period data and location data.

Clause 10. The method according to any one of Clauses 1-9, wherein the theme data is associated with an animation theme of the light effect.

Clause 11. The method according to any one of Clauses 1-10, wherein the period data is associated with data used to calculate which time period in the animation theme the current time corresponds to.

Clause 12. The method according to any one of Clauses 1-11, wherein the location data is associated with x and y coordinates of vertices in the vertex information table, and a size of a unit canvas.

Clause 13. The method according to any one of Clauses 1-12, wherein the unit canvas is a logical 2D area for rendering one complete cycle of an animation light effect.

Clause 14. The method according to any one of Clauses 1-13, wherein the size of a unit canvas includes a length of the unit canvas and a width of the unit canvas, wherein the length and the width vary depending on the orientation.

Clause 15. The method according to any one of Clauses 1-14, wherein the orientation of the light assembly is represented by an orientation index, the vertex information table and the orientation index are received by the downstream panel via a command from the controller, and are forward to each light panel along the topology.

Clause 16. The method according to any one of Clauses 1-15, wherein the discovering of the topology is triggered as the controller is initially started after the light assembly is powered up, or as a topology change is detected.

Clause 17. The method according to any one of Clauses 1-16, wherein the topology change is detected by each light panel as one or more new light panels are added to the light assembly or as one or more existing light panels are removed from the light assembly.

Clause 18. The method according to any one of Clauses 1-17, wherein the vertex information table is updated as the discovering the topology is complete, as the topology change is detected and an update for the topology is complete, or an orientation change is detected.

Clause 19. The method according to any one of Clauses 1-18, wherein the vertex information table is updated as the discovering the topology is complete, as the topology change is detected and an update for the topology is complete, or an orientation change is detected.

Clause 20. In some embodiments, a light assembly comprising: a plurality of light panels configurable to connect with one another; and a controller configurable to connect to a downstream panel of the plurality of light panels; wherein the controller is configured to derive a vertex information table based on a topology information table received from the downstream panel and an orientation of the light assembly, wherein the topology information table is indicative a topology of the plurality of light panels in the light assembly; and wherein each light panel of the plurality of light panels includes a panel controller configured to: receive and store the vertex information table; calculate light effect data for each vertex of the light panel based on the vertex information table; and control one or more light elements located on each vertex of the light panel to render light effect, based on the calculated light effect data for each vertex of the light panel.

The descriptions of the various embodiments have been presented for purposes of illustration, but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

1. A method for a light assembly, wherein the light assembly includes a plurality of light panels connected with one another and a controller connected to a downstream panel of the plurality of light panels, the method comprising:
discovering, by the plurality of light panels, a topology of the plurality of light panels in the light assembly to derive a topology information table;
deriving, by the controller, a vertex information table based on the topology information table received from the downstream panel and an orientation of the light assembly;
calculating, by each light panel, light effect data for each vertex of each light panel based on the vertex information table and upon receiving a timing clock signal from the controller; and
rendering light effect, by each light panel, based on the calculated light effect data for each vertex of each light panel.

2. The method according to claim 1, wherein the topology information table is indicative of logical connections in the topology for the plurality of light panels in the light assembly.

3. The method according to claim 1, wherein the vertex information table is indicative of relative location information for each vertex of each light panel in the light assembly.

4. The method according to claim 1, wherein the orientation of the light assembly is detected by the controller and is associated with an orientation angle of the controller.

5. The method according to claim 1, wherein the deriving the vertex information table comprises:
calculating all x and y coordinates of all vertices of the downstream panel, based on the topology information table, a lookup table and the orientation; and
calculating all x and y coordinates of all vertices of all remaining light panels downstream of the downstream panel along the topology, based on the topology information table, the lookup table and the orientation.

6. The method according to claim 5, wherein the lookup table is predefined and includes mapping relations including one or more of:
panel types for the light panels,
reference side IDs for reference sides,
reference side orientations indicative of rounded angles between the reference sides of the downstream panel and a horizontal axis in a positive orientation,
X and Y values of reference vertices of the reference sides, or
X and Y values of remaining vertices of the light panels.

7. The method according to claim 1, wherein the calculating light effect data for each vertex of each light panel is further comprising calculating light effect data for each vertex of each light panel based on a theme indicated by a theme mode command received from the controller, the orientation and the vertex information table.

8. The method according to claim 1, wherein the rendering light effect by each light panel further comprising rendering light effect based on the light effect data for each vertex of each light panel and the orientation.

9. The method according to claim 8, wherein the light effect data is calculated based on theme data, period data and location data.

10. The method according to claim 9, wherein the theme data is associated with an animation theme of the rendering light effect.

11. The method according to claim 10, wherein the period data is associated with data used to calculate which time period in the animation theme a current time corresponds to.

12. The method according to claim 9, wherein the location data is associated with x and y coordinates of vertices in the vertex information table, and a size of a unit canvas.

13. The method according to claim 12, wherein the unit canvas is a logical 2D area for rendering one complete cycle of an animation light effect.

14. The method according to claim 13, wherein the size of a unit canvas includes a length of the unit canvas and a width of the unit canvas, wherein the length and the width vary depending on the orientation.

15. The method according to claim 1, wherein the orientation of the light assembly is represented by an orientation index, the vertex information table and the orientation index are received by the downstream panel via a command from the controller, and are forward to each light panel along the topology.

16. The method according to claim 1, wherein the discovering of the topology is triggered as the controller is initially started after the light assembly is powered up, or as a topology change is detected.

17. The method according to claim 16, wherein the topology change is detected as one or more new light panels are added to the light assembly or as one or more existing light panels are removed from the light assembly.

18. The method according to claim 16, wherein the vertex information table is updated as the discovering the topology is complete, as the topology change is detected by each light panel and an update for the topology is complete, or an orientation change is detected.

19. The method according to claim 1, wherein the plurality of light panels have at least one shape of a hexagon, a diamond and a triangle.

20. A light assembly comprising:
a plurality of light panels configurable to connect with one another; and
a controller configurable to connect to a downstream panel of the plurality of light panels;
wherein the controller is configured to derive a vertex information table based on a topology information table received from the downstream panel and an orientation of the light assembly, and the topology information table is indicative a topology of the plurality of light panels in the light assembly; and
wherein each light panel of the plurality of light panels includes a panel controller configured to:
receive and store the vertex information table; and
calculate light effect data for each vertex of the light panel based on the vertex information table; and
control one or more light elements located on each vertex of the light panel to render light effect, based on the calculated light effect data for each vertex of the light panel.
